(19) United States
(12) Patent Application Publication
(10) Pub. No.: US 2013/0007424 A1
(43) Pub. Date: Jan. 3, 2013

(54) CASCADING INDIRECT BRANCH INSTRUCTIONS

(76) Inventor: Richard C. Gorton, JR., Framingham, MA (US)

(21) Appl. No.: 13/172,690

(22) Filed: Jun. 29, 2011

(51) Int. Cl. G06F 9/38

(52) U.S. Cl. 712/239; 712/E09.06

(57) ABSTRACT

Techniques are disclosed relating to improving misprediction rates of indirect branch instructions. In one embodiment, a computer system determines misprediction information for an indirect branch instruction included in a sequence of instructions. The misprediction information is indicative of a processor not correctly predicting an actual target address of the indirect branch instruction. In some embodiments, the misprediction information includes a misprediction rate for the target address). Based on the misprediction information, the computer system inserts before the indirect branch instruction a conditional branch instruction that specifies the target address.

### BACKGROUND

1. Technical Field

This disclosure relates generally to processors, and, more specifically, to improving branch prediction of branch instructions.

2. Description of the Related Art

To improve instruction throughput, modern processors may include a branch prediction unit configured to predict the outcomes of control transfer instructions before they are executed. Branch prediction units typically predict outcomes by storing a history of previous outcomes and using the history to predict future ones. These predicted outcomes are then used to fetch potential instructions for execution.

Branch prediction units are typically configured to predict the outcomes of a type of control transfer instruction referred to as an “indirect branch,” “indirect jump,” or “indirect call” instruction. This instruction may be used in various applications (such as switch statements) in which the address of the next instruction for execution may not be known until runtime. When such an instruction is executed, a processor may retrieve a memory address stored in a register (or memory) and load it into a program counter as the next instruction for execution.

### SUMMARY OF EMBODIMENTS

The present disclosure describes various embodiments of systems and methods relating to improving misprediction rates of indirect branch instructions.

In one embodiment, a computer readable medium is disclosed that has program instructions stored thereon. The program instructions are executable by a processor to cause a computer system to perform determining misprediction information for an indirect branch instruction included in a sequence of instructions. The misprediction information is indicative of the processor not correctly predicting an actual target address of the indirect branch instruction. The program instructions are further executable to perform, based on the misprediction information, inserting before the indirect branch instruction a conditional branch instruction that specifies the target address.

In another embodiment, a method is disclosed. The method includes determining a misprediction rate for a target address of an indirect branch instruction. The method further includes, based on the misprediction rate, inserting a conditional branch instruction into a sequence of instructions that includes the indirect branch instruction. The conditional branch instruction specifies the target address.

In still another embodiment, a computer readable medium is disclosed that has program instructions stored thereon. The program instructions include a first conditional branch instruction executable to cause a processor to jump to a first target address based on a comparison of the first target address with an address stored in a register of the processor. The program instructions further include an indirect branch instruction located after the first conditional branch instruction. The indirect branch instruction is executable to cause a processor to jump to the address stored in the register. The first target address is one of a plurality of target addresses of the indirect branch instruction.

### BRIEF DESCRIPTION OF THE DRAWINGS

FIG. 1 is a block diagram illustrating one embodiment of a computer system configured to perform branch prediction of indirect branch instructions.

FIG. 2 is a block diagram illustrating one embodiment of a branch prediction unit in a processor of the computer system.

FIG. 3 is a block diagram illustrating one embodiment of a transformation module stored in a memory of the computer system.

FIG. 4 illustrates a set of exemplary code samples.

FIG. 5 is a flow diagram illustrating one embodiment of a method for transforming a sequence of instructions based on a misprediction rate for a target address.

FIG. 6 is a flow diagram illustrating one embodiment of a method for transforming a sequence of instructions based on an average misprediction rate for multiple target addresses.

FIG. 7 is a flow diagram illustrating one embodiment of a method for transforming a sequence of instructions based on an average misprediction rate for a set of target addresses and their respective misprediction rates.

FIG. 8 is a flow diagram illustrating one embodiment of a method for transforming a sequence of instructions based on a total misprediction rate of an indirect branch instruction.

FIG. 9 is a flow diagram illustrating one embodiment of a method for transforming a sequence of instructions based on a respective target frequency of one or more target addresses.

FIG. 10 is a block diagram illustrating one embodiment of an exemplary computer system.

### DETAILED DESCRIPTION

This specification includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

Terminology. The following paragraphs provide definitions and/or context for terms found in this disclosure (including the appended claims):

“Comprising.” This term is open-ended. As used in the appended claims, this term does not foreclose additional structure or steps. Consider a claim that recites: “An apparatus comprising one or more processor units . . . .” Such a claim does not foreclose the apparatus from including additional components (e.g., a network interface unit, graphics circuitry, etc.).

“Configured To.” Various units, circuits, or other components may be described or claimed as “configured to” perform a task or tasks. In such contexts, “configured to” is used to connote structure by indicating that the units/circuits/components include structure (e.g., circuitry) that performs those task or tasks during operation. As such, the unit/circuit/component can be said to be configured to perform the task even when the specified unit/circuit/component is not currently operational (e.g., is not on). The units/circuits/components used with the “configured to” language include hardware—for example, circuits, memory storing program instructions executable to implement the operation, etc. Reciting that a unit/circuit/component is “configured to” perform one or more tasks is expressly intended not to invoke 35 U.S.C.§112, sixth paragraph, for that unit/circuit/component. Additionally, “configured to” can include generic structure (e.g., generic circuitry) that is manipulated by software and/or firmware (e.g., an FPGA or a general-purpose processor executing software) to operate in manner that is capable of performing the task(s) at issue. “Configure to” may also include adapting a manufacturing process (e.g., a semiconductor fabrication facility) to fabricate devices (e.g., integrated circuits) that are adapted to implement or perform one or more tasks.

“First,” “Second,” etc. As used herein, these terms are used as labels for nouns that they precede, and do not imply any type of ordering (e.g., spatial, temporal, logical, etc.). For example, in a sequence of instructions, the terms “first” and “second” instructions can be used to refer to any two instructions of the sequence regardless of program order. In other words, the “first” instruction may come after the “second” instruction in program order.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

“Processor.” This term has its ordinary and accepted meaning in the art, and includes a device that is capable of executing instructions. A processor may refer, without limitation, to a central processing unit (CPU), a co-processor, an arithmetic processing unit, a graphics processing unit, a digital signal processor (DSP), etc. A processor may be a superscalar processor with a single or multiple pipelines. A processor may include a single or multiple cores that are each configured to execute instructions.

“Control Transfer Instruction.” This term has its ordinary and accepted meaning in the art, and includes a program instruction that is executable to change the order in which program instructions are executed (also referred to as control flow or program order). Control transfer instructions are also be referred to herein as branch instructions and include jump instructions, call instructions, return instructions, trap instructions, etc.

“Direct Branch Instruction.” This term has its ordinary and accepted meaning in the art, and includes a control transfer instruction that includes encoded bits of a memory address (referred to as a target address) or an offset used to calculate a target address of the next instruction (or block of instructions) for execution. For example, the x86instruction JMP 0x89AB is a direct branch instruction that specifies the target address 0x89AB. When the instruction is executed, the processor loads the register IP (the program counter) with 0x89AB and begins executing instructions from that address.

“Indirect Branch Instruction.” This term has its ordinary and accepted meaning in the art, and includes a control transfer instruction that does not explicitly specify a target address or offset, but rather specifies a storage element (e.g., a register, memory, etc.) that includes the target address or offset. The x86 instruction JMP EAX is one example of an indirect branch instruction, which is executable to cause a processor to load register IP with the address stored in register EAX and begin executing instructions from that address.

“Conditional Branch Instruction.” This term has its ordinary and accepted meaning in the art. In contrast to a “non-conditional” branch instruction that always changes control flow without testing any conditions (e.g., JMP 0x89AB), a conditional branch instruction causes a change in control flow based on a specified condition being satisfied. For example, the x86 instruction JE 0x89AB is a conditional branch instruction that causes a processor to jump to a particular target address if two values are equal as specified by its opcode. A comparison instruction (e.g., CMP EAX EBX, which compares the contents of the EAX and EBX registers) may be executed before a conditional branch instruction to perform the comparison. In this disclosure, the term conditional branch instruction refers to a direct conditional branch instruction. It is noted, however, that some ISAs may support an indirect form of a conditional branch instruction.

“Branch Misprediction.” This term has its ordinary and accepted meaning in the art, and includes the incorrect prediction by a branch prediction unit of the outcome of a control transfer instruction. In some instances, if a branch misprediction occurs, a processor may stop executing instructions along one path and initiate executing instructions along another path.

“Misprediction rate.” This term has its ordinary and accepted meaning in the art, and includes a frequency at which a target address or set of target addresses is mispredicted. A misprediction rate may be expressed as a percentage, ratio, etc., over some time period. For example, a target address T1 has a misprediction rate of 20% if the branch prediction unit mistakenly predicts another address 20% of the time when T1 is the actual target address (i.e., the determined target address of the indirect branch instruction if and when that instruction is executed).

“Target frequency.” As used herein, this term refers to a frequency at which an address is used as the target address of an indirect branch instruction. This frequency may be expressed as percentage, ratio, etc. For example, an address T1 has a target frequency of 20% if an indirect branch instruction uses T1 as its target address 20% of the time and another address T2 as the target address 80% of the time.

Predicting outcomes of indirect branch instructions can be more difficult for branch prediction units than predicting outcomes of conditional branch instructions. To predict the outcome of a conditional branch instruction, a branch prediction unit merely needs to predict a direction (i.e., taken or not taken) for the specified condition. This prediction may be performed using a simple strength counter, which is incremented or decremented based on previous executions of the instruction. To predict the outcome of an indirect branch instruction, a branch prediction unit needs to predict the target address of that instruction (the branch prediction unit does not do this for a conditional branch instruction because, as discussed above, the instruction specifies the target address). Predicting a target address may include determining previously used target addresses and identifying patterns for those addresses, which use more processor resources, take longer to perform, and consume more power than predicting a direction. Even still, a branch prediction unit is more likely to incorrectly predict a target address than it is to incorrectly predict a direction. Frequent mispredictions of target addresses can severally impair instruction throughput while wasting time and energy.

The present disclosure describes techniques to lower the misprediction rates of indirect jump instructions. As will be described below, in various embodiments, a processor may include a branch prediction unit that includes logic (i.e., a conditional branch prediction unit) for predicting outcomes of conditional branch instructions (e.g., directions) and logic (i.e., an indirect branch prediction unit) for predicting outcomes of indirect branch instructions (e.g., target addresses). The processor may store misprediction information (e.g., in the indirect branch prediction unit) for target addresses of indirect branch instructions. In various embodiments, a processor may execute instructions of a transformation module that reads this information and determines whether to modify an instruction sequence based on the misprediction rates of target addresses. In one embodiment, if the mispredictions rates of target addresses for a particular indirect branch exceed a threshold (other criteria may be used in other embodiments such as described below), the transformation module is executable to insert conditional branch instructions before the indirect branch instruction, where the conditional branch instructions specify the mispredicted target addresses of the indirect branch instruction. (This insertion process may also be referred to herein as “cascading.”)

In one embodiment, the inserted conditional branch instructions specify a respective one of the mispredicted target addresses as its target address based on the condition that the specified target address is equal to the actual target address for the indirect branch instruction—said another way, that the target address specified by the instruction is equal to the correct target address determined if and when the indirect branch instruction is executed. For example, in one instance, the x86 instruction JMP EAX may be executable to cause a processor to jump to one of three possible target addresses T1, T2, and T3 stored in the register EAX (techniques described herein may, of course, be applicable to any suitable ISA). In one embodiment, if a branch prediction unit frequently incorrectly predicts target address T1 (i.e. it should predict T1, but instead predicts T2 or T3), a conditional branch instruction that specifies the mispredicted target address T1 is inserted before the indirect branch instruction—e.g., the x86 instruction JE T1, which causes a processor to jump to T1 if two values are equal. In some embodiments, a compare instruction may also be inserted before the conditional branch instruction—e.g., CMP EAX T1, which causes a processor to compare the value in EAX with the address T1 and to set corresponding bits that are examined upon execution of the conditional branch. Thus, in one embodiment, the transformation module may modify a sequence that includes JMP EAX to include: CMP EAX T1; JE T1; JMP EAX.

In various embodiments, inserting conditional branch instructions in this manner causes the conditional branch prediction unit to be involved in the prediction of the indirect branch instruction and, in some instances, replaces the need to use the indirect branch prediction unit. This involvement occurs because the conditional branch prediction unit is predicting whether a tested condition is true or not when it is predicting a direction. Since the tested condition specified by an inserted conditional branch instruction, in various embodiments, is whether a specified address is the correct address, the unit is predicting whether this condition is true when it predicts a direction. If the conditional branch prediction unit predicts that this condition is true (and thus that the specified address of the conditional branch instruction is likely the correct target address for the indirect branch instruction), the indirect branch prediction unit may not be used, since control flow proceeds down the execution path of the conditional branch, which does not include the indirect branch instruction. If the conditional branch prediction unit is wrong or predicts that none of the conditional branches will be taken, control flow proceeds down the execution path that includes the indirect branch instruction, and the indirect branch prediction unit is then used to predict the outcome of the indirect branch instruction.

Since the conditional branch prediction unit predicts directions, it is generally a more accurate predictor than the indirect branch prediction unit, which predicts target addresses. When the conditional branch prediction unit can be used to predict outcomes of indirect branch instructions mispredicted by the indirect branch prediction unit, lower misprediction rates for those instructions can be achieved in many instances. These lower rates result in less stalls/bubbles and higher instruction throughput.

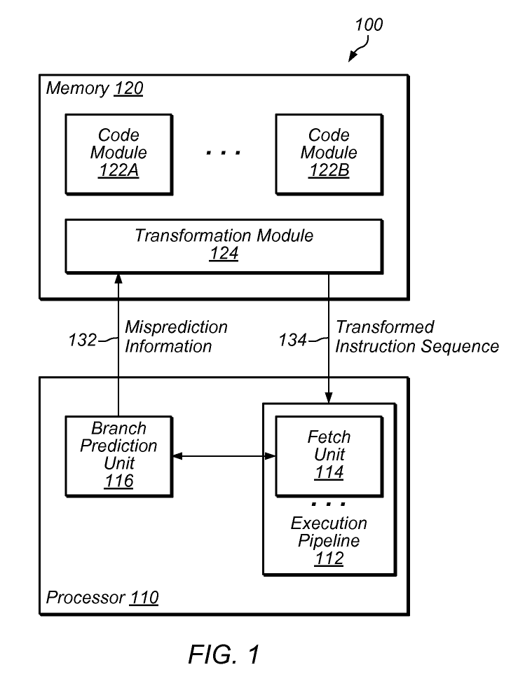

Turning now to FIG. 1, a block diagram of a computer system 100 is depicted. Computer system 100 is one embodiment of a computer system configured to perform branch prediction of indirect branch instructions. In the illustrated embodiment, computer system 100 includes a processor 110 and memory 120. Processor 110 includes an execution pipeline 112, fetch unit 114, and a branch prediction unit 116. Memory includes program instructions for ones or more code modules 122A-B and transformation module 124. It is noted that, although module 124 is shown as a single module for illustration purposes, multiple separate modules may, in some embodiments, implement module 124; in some embodiments, these modules may also be executed by separate processors or separate cores within a single processor.

Processor 110 may be any suitable type of processor that supports indirect branch instructions in its instruction set architecture (ISA). Processor 110 may be a general-purpose processor such as a central processing unit (CPU). Processor 110 may be a special-purpose processor such as an accelerated processing unit (APU), digital signal processor (DSP), graphics processing unit (GPU), etc. Processor 110 may be acceleration logic such as an application-specific integrated circuit (ASIC), field-programmable gate array (FPGA), etc. Processor 110 may be a multi-threaded superscalar processor.

Fetch unit 114, in one embodiment, is configured to fetch instructions for execution by processor 110 in execution pipeline 112. In various embodiments, fetch unit 114 may fetch instructions based on a memory address (referred to as a program-counter address) stored in a particular register (referred to as a program counter) maintained by processor 110. The program counter may be adjusted as instructions are fetched to point to the next instruction in program order. If a fetched instruction is not a control transfer instruction, the program-counter address may be incremented by an amount based on the instruction's width (or based on the width of multiple instructions in an instruction block). If a fetched instruction is a control transfer instruction, the program counter may be adjusted based on a direction and/or target address of that instruction. In various embodiments, fetch unit 114 adjusts the program counter based on prediction information provided by branch prediction unit 116 and continues speculatively fetching instructions while the control transfer instruction is executed.

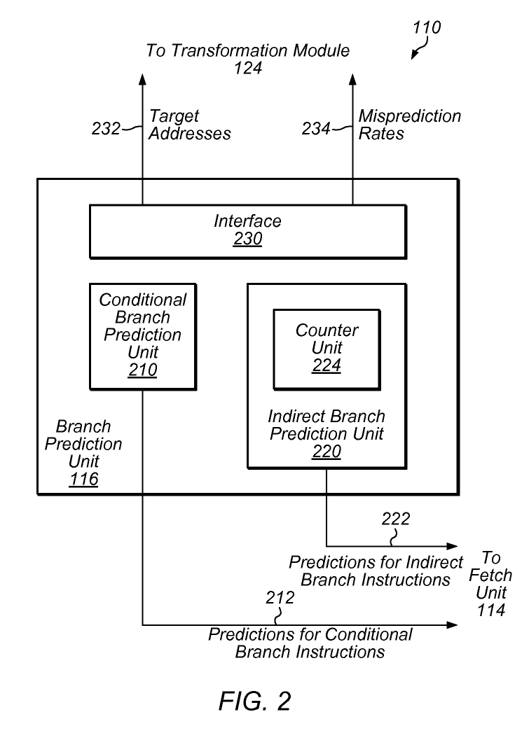

Branch prediction unit 116, in one embodiment, is configured to predict outcomes of control transfer instructions to assist fetch unit 114 in determining the direction of control flow. Branch prediction unit 116 may predict any of a variety of information usable by fetch unit 114 such as directions (i.e., whether a particular branch will be taken or not), target addresses, return addresses, etc. To facilitate these predictions, branch prediction unit 116, in various embodiments, maintains statistical information indicative of outcomes from previously executed instructions. This statistical information may include indications of previously taken directions, a history of previous target addresses, etc. In some embodiments, branch prediction unit 116 may also store additional statistical information that includes misprediction rates, target frequencies, etc. (Some of this information may not necessarily be used for predictions. In some embodiments, this information may be collected by logic other than branch prediction unit 116.) In various embodiments, this statistical information may be accessible to software in memory 120 such as transformation module 124 (e.g., through the use of instruction-based sampling (IBS), in some embodiments, described below). Branch prediction unit 116 is described in further detail below in conjunction with FIG. 2.

Code modules 122 are representative of any suitable software that uses indirect branch instructions. As will be described below, modules 122 may be stored in memory 120 in various forms. In some embodiments, modules 122 are stored in memory 120 as low-level instructions executable by processor 110 (i.e., as program instructions supported by the ISA of processor 110). In some embodiments, modules 122 may be stored as intermediate-level instructions (e.g., microcode), which is translated/interpreted into instructions executable by processor 110. In some embodiments, modules 122 may be stored as high-level instructions (i.e., as source code for, e.g., C++, C#, JAVA, etc.), which may be dynamically complied at runtime to produce executable program instructions.

Transformation module 124, in one embodiment, includes program instructions executable to improve misprediction rates of indirect branch instructions by producing transformed instruction sequences 134 from modules 122. As will be described below, in various embodiments, module 124 may read a module 122 from memory 120 and produce a corresponding transformed instruction sequence 134. In various embodiments, module 124 determines misprediction information 132 for target addresses of indirect branch instructions. Module 124 then inserts, based on the misprediction information, conditional branch instructions (and, in some embodiments, compare instructions) before the indirect branch instructions to produce transformed instruction sequences 134. In some embodiments, transformation module 124 performs this insertion (as well as any conversion of modules 122 into executable program instructions) while portions of sequences 134 are executing (i.e., at runtime). Thus, module 124 may insert conditional branch instructions as misprediction information 132 is being updated in real-time.

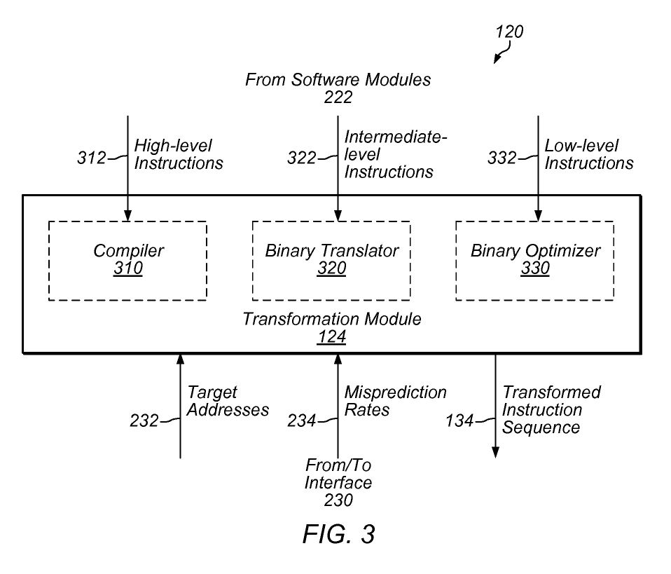

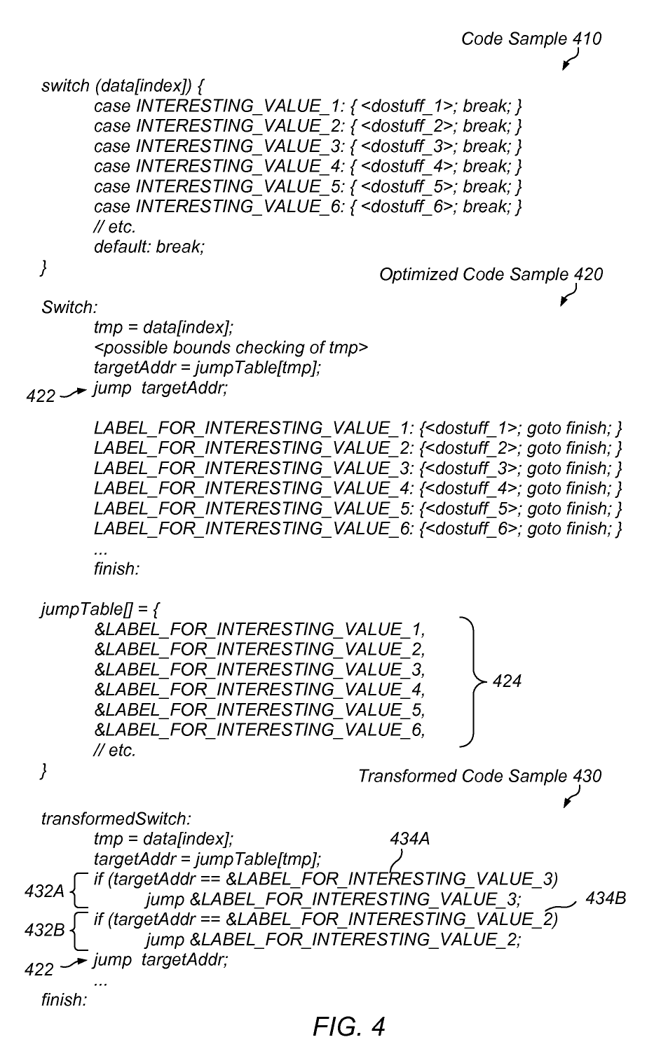

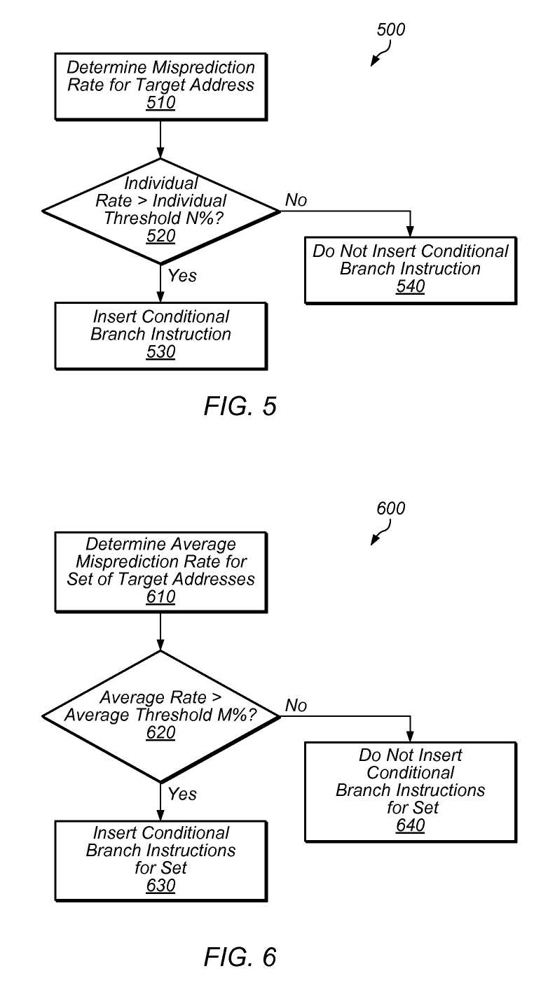

As discussed above, in one embodiment, module 124 inserts conditional branch instructions that each specify a respective target address of an indirect branch instruction as its target address based on a comparison of that address with the actual target address. For example, an indirect branch instruction may have a target address T1, which is frequently mispredicted. Module 124 may insert a conditional branch instruction that specifies target address T1 as its target address based on T1 and the actual target address of the indirect branch instruction being equal. In one embodiment, if branch prediction unit 116 predicts that a conditional branch of an inserted conditional branch instruction will be taken (indicating that the target address for that conditional branch instruction is likely the target address for the indirect branch instruction), control flow proceeds down the path of the branch that does not include the indirect branch instruction. If, however, branch prediction unit 116 predicts that the conditional branch will not be taken (indicating that the target address is not likely the target address for the indirect branch instruction), control flow proceeds down the path that includes the indirect branch instruction. Module 124 is described in further detail below in conjunction with FIG. 3. An example illustrating the insertion of a conditional branch instruction is described below in conjunction with FIG. 4. Various criteria used by module 124 to determine whether to insert conditional branch instructions are described below in conjunction with FIGS. 5-9.

Turning now to FIG. 2, one embodiment of branch prediction unit 116 is depicted. In the illustrated embodiment, branch prediction unit 116 includes conditional branch prediction unit 210, indirect branch prediction unit 220, and interface 230. It is noted that units 210 and 220 are shown as separate units for illustrative purposes; in some embodiments, these units may share common logic—i.e., logic used for both the prediction of conditional branch instructions and indirect branch instructions. In some embodiments, branch prediction unit 116 may include additional units for predicting outcomes of other types of control transfer instructions. In some embodiments, interface 230 may be considered as external to branch prediction unit 116.

Conditional branch prediction unit 210, in one embodiment, is configured to generate predictions 212 for conditional branch instructions including those inserted by module 124. Prediction unit 210 may use any of a variety of techniques to generate predictions 212. In various embodiments, prediction unit 210 generates predictions 212 by using strength counters, which are updated based on previous executions of conditional branch instructions. In many instances, prediction unit 210 has lower misprediction rates than prediction unit 220 has.

Indirect branch prediction unit 220, in one embodiment, is configured to generate predictions for indirect branch instructions. Prediction unit 220 may use any of a variety of techniques to generate predictions 222. In various embodiments, prediction unit 220 stores target addresses and corresponding history information in counter unit 224. This history information may include an ordering of the last taken target addresses, indications of detected patterns of taken target addresses, target address frequencies collected from previous executions of indirect branch instructions, etc.

In one embodiment, counter unit 224 is further configured to store statistical information about indirect branch instructions such as information indicative of misprediction rates for target addresses, total misprediction rates for indirect branch instructions, etc. In some embodiments, this statistical information may be collected by logic elsewhere in processor 110 such as within interface 230 or even outside of branch prediction unit 116.

Interface 230, in one embodiment, is configured to provide statistical information including target addresses 232 and misprediction rates 234 of indirect branch instructions to software in memory 120 such as transformation module 124. In some embodiments, interface 230 may provide other statistical information about branch prediction unit 116 and/or processor 110. In one embodiment, interface 230 is usable to implement instruction-based sampling (IBS), which tracks statistical information about executing instructions—this information may be used to test the integrity of processor 110, as input for a debugger to test executing software, etc.

Turning now to FIG. 3, one embodiment of a transformation module 124 is depicted. As discussed above, in various embodiments, module 124 improves mispredictions rates for indirect branch instructions by inserting condition branch instructions into a transformed instruction sequence 134. As shown, module 124 may include a compiler 310, binary translator 320, or binary optimizer 330. It is noted that modules 310-330 are depicted using a dotted line to illustrated that module 124 may not include all of modules 310-330 in some embodiments. For example, module 124 may only include binary optimizer 330 in one embodiment.

Compiler 310, in one embodiment, is executable to compile high-level instructions 312 of modules 122 to produce transformed instruction sequence 134. (In other embodiments, compiler 310 may compile high-level instructions 312 into a form that is provided to binary translator 320 or binary optimizer 330 to produce instructions 134.) Compiler 310 may support any of a variety of high-level programming languages. In various embodiments, compiler 310 is further executable to insert conditional branch instructions based on target addresses 232 and misprediction rates 234. In some embodiments, compiler 310 may insert conditional branch instructions as it is compiling instructions 312 or after compiling instructions 312. For example, compiler 310 may identify an indirect branch instruction in a compiled sequence of instructions and insert one or more corresponding conditional branch instructions based on information 232 and 234. In other embodiments, compiler 310 causes the insertion of conditional branch instructions by modifying high-level instructions 312 before compilation. For example, compiler 310 may determine that a sequence of instructions will use an indirect branch instruction upon compilation. Compiler 310 may then modify the high-level instructions 312 to cause the insertion of conditional branch instructions on compilation. In some embodiments, compiler 310 may insert conditional branch instructions while portions of transformed instruction sequence 134 are being executed by processor 110.

Binary Translator 320, in one embodiment, is executable to translate (i.e., interpret) intermediate-level instructions 322 into transformed instructions 134. (In another embodiment, translator 320 translates instructions 322 into a form that is provided to binary optimizer 330, which produces instructions 134.) In various embodiments, translator 320 is further executable to insert conditional branch instructions based on target addresses 232 and misprediction rates 234. In some embodiments, translator 320 may insert conditional branch instructions after translating instructions 322. For example, translator 320 may identify an indirect branch instruction in a translated sequence of instructions and insert one or more corresponding conditional branch instructions based on information 232 and 234. In other embodiments, translator 320 causes the insertion of conditional branch instructions by modifying intermediate-level instructions 322 before translation. For example, translator 320 may determine that a sequence of instructions 322 includes an indirect branch instruction—albeit not in a form supported by processor 110's ISA. Translator 320 may then insert a conditional branch instruction as it is translating the indirect branch instruction into a low-level instruction. In some embodiments, translator 320 may insert conditional branch instructions at runtime.

Dynamic binary optimizer 330, in one embodiment, is executable to optimize low-level instructions 332 for execution by processor 110. In various embodiments, optimizer 330 produces instructions 134 by inserting conditional branch instructions into instructions 322 based on target addresses 232 and misprediction rates 234. For example, optimizer 330 may determine that a sequence of instructions 332 includes an indirect branch instruction by decoding instructions 332. Optimizer 330 may then insert one or more corresponding conditional branch instructions based on information 232 and 234. In some embodiments, optimizer 330 may insert conditional branch instructions at runtime.

Turning now to FIG. 4, a set of exemplary code samples 410-430 is depicted. As shown, code sample 410 includes a sequence of instructions corresponding to a switch statement. As will be described below, a compiler (e.g., compiler 310) may optimize the switch statement with an indirect jump (shown as jump 422 in optimized code sample 420), which is implemented using an indirect branch instruction. In various embodiments, transformation module 124 transforms the optimized code sample 420 into transformed code sample 430 by inserting if statements (or compare instructions and conditional branch instructions corresponding to if statements, in some embodiments). This insertion (as discussed above) may result in fewer mispredictions of the indirect branch instruction in many instances.

When the statement is executed in code sample 410 is executed, control flow is determined based on the value stored in data[index] and the values specified by the case statements (i.e., one of INTERESTING_VALUE_{—}1-INTERESTING_VALUE_{—}6). If the value of data[index] matches one of the specified values, the instructions associated with that case statement are executed (i.e., the instructions corresponding to one of the labels <dostuff_{—}1>-<dostuff_{—}6>). For example, if the value stored in data[index] equals INTERESTING_VALUE_{—}3, instructions corresponding to the label <dostuff_{—}3> are executed. To implement the switch statement, the value stored in data[index] may be compared with each of the case-statement values. Performing multiple comparisons, however, can be time consuming. In many instances, using an indirect branch instruction to perform an indirect jump is a better approach.

Code sample 420 (which may be produced by a compiler from code 410) depicts a switch statement that is performed using an indirect jump 422. In code sample 420, the case statements are replaced with corresponding labels (i.e., LABEL_FOR_INTERESTING_VALUE_{—}1-LABEL_FOR_INTERESTING_VALUE_{—}6). These labels are used by the compiler to identify the first instruction of each set of instructions corresponding to <dostuff_{—}1>-<dostuff_{—}6>. A jump table 424 is also added, which includes the addresses corresponding to the labels. Note that the address of a variable can be referenced in the programming language C by appending the character ‘&’ to the variable's name. Thus, &LABEL_FOR_INTERESTING_VALUE_{—}1 refers to the address of LABEL_FOR_INTERESTING_VALUE_{—}1; this address is also the address of the first instruction in <dostuff_{—}1>. When code sample 420 is executed, the value of data[index] is used to determine an address using jump table 424. This determined address is then used as the target address for jump 422.

In the illustrated embodiment, jump 422 is implemented using an indirect branch instruction, which has the target addresses &LABEL_FOR_INTERESTING_VALUE_{—}1-&LABEL_FOR_INTERESTING_VALUE_{—}6. In various embodiments, module 124 may identify jump 422 (or the indirect branch instruction corresponding to jump 422) in code sample 420 and insert conditional branch instructions based on the misprediction rates of target addresses &LABEL_FOR_INTERESTING_VALUE_{—}1-&LABEL_FOR_INTERESTING_VALUE_{—}6.

Code sample 430 corresponds to the situation in which target address &LABEL_FOR_INTERESTING_VALUE_{—}2 (also shown as address 434B) and target address &LABEL_FOR_INTERESTING_VALUE_{—}3 (also shown as address 434A) are determined to have high misprediction rates. In the illustrated embodiment, two if statements 432A and 432B for target addresses 434A and 434B have been inserted into code 420 before jump 422 to produce code sample 430. The first if statement 432A compares the target address targetAddr (i.e., the actual target address for jump 422) with the mispredicted target address 434A. If they match, a jump is performed using address 434A as the target address for the jump. The second if statement 432B is performed in a similar manner with mispredicted target address 434B. When code sample 430 is compiled, if statements 432A and 432B may be represented in the compiled low-level instructions as conditional branch instructions (compare instructions may also be inserted to set the appropriate bits for the conditional branch instructions, depending upon the supported ISA). Jump 422 may also be represented as an indirect branch instruction in the compiled low-level instructions. As discussed above, the insertion of conditional branch instructions may reduce the misprediction rates for target addresses 434A and 434B of the indirect branch instruction.

In some embodiments, the ordering of if statements 432 (or their corresponding conditional branch instructions) may be determined based on one or more criteria. For example, in one embodiment, module 124 orders inserted conditional branch instructions based on target frequency. Thus, if statement 432A may be inserted before if statement 432B if target address 434A has a higher target frequency than target address 434B (e.g., a target frequency of 40% versus a target frequency of 20%). Other criteria for determining order are described below.

Various criteria for determining whether to insert conditional branch instructions are now discussed in conjunction with FIGS. 5-9.

Turning now to FIG. 5, a flow diagram of a method 500 for transforming a sequence of instructions based on a misprediction rate for a target address is depicted. Method 500 is one embodiment of a method that may be performed by a computer system such as computer system 100 executing module 124. In various embodiments, method 500 may be performed for multiple target addresses of multiple indirect branch instructions identified in a sequence of instructions. In many instances, performance of method 500 reduces mispredictions for indirect branch instructions.

In step 510, computer system 100 (e.g., using module 124) determines a misprediction rate for a target address of an indirect branch instruction. (This misprediction rate may be referred to herein as an “individual” or “respective” misprediction rate as it corresponds to a single target address—as opposed to an average misprediction rate or total misprediction rate, which (as described with subsequent methods) are determined based on multiple target addresses.) In various embodiments, step 510 may include reading and processing statistical information maintained by a processor such as reading information from counter unit 224 via interface 230 as described above.

In step 520, computer system 100 determines whether the individual rate is greater than an individual threshold N %. In various embodiments, individual threshold N % may be selected to maximize instruction throughput. If computer system 100 determines that the individual rate (e.g., 40%) is greater than the individual threshold N % (e.g., 20%), method 500 proceeds to step 530. Otherwise, method 500 proceeds to step 540.

In step 530, computer system 100 inserts a conditional branch instruction for the target address. As discussed above, in various embodiments, the inserted conditional branch instruction may be placed before the indirect branch instruction and take the form: if specified target address equals actual target address, jump to specified target address. In various embodiments, computer system 100 may insert the instruction using a compiler (such as compiler 310), binary translator (such as translator 320), or binary optimizer (such as optimizer 330). In some embodiments, computer system 100 may insert the instruction at runtime. In some embodiments, if computer system 100 has already inserted one or more conditional branch instructions, computer system 100 may place the condition branch instruction based on an ordering defined by one or more criteria. For example, as noted above, computer system 100 may order inserted conditional branch instructions based on target frequency such that conditional branch instructions of more-frequently-used target addresses are placed before those of less-frequently-used target addresses. In another embodiment, computer system 100 may order inserted conditional branch instructions based on misprediction rates such that conditional branch instructions of more-frequently-mispredicted target addresses are placed before those of less-frequently-mispredicted target addresses.

In step 540, computer system 100 does not insert a conditional branch instruction for the target address. As noted above, if no conditional branch instruction is inserted and the target address turns out to be the actual target address, the indirect branch instruction, in various embodiments, is allowed to execute and uses the target address as its actual target address.

Turning now to FIG. 6, a flow diagram of a method 600 for transforming a sequence of instructions based on an average misprediction rate for multiple target addresses is depicted. Method 600 is another embodiment of a method that may be performed by a computer system such as computer system 100 executing module 124. Performance of method 600 may produce similar benefits as those produced by method 500.

In step 610, computer system 100 determines an average misprediction rate for a set of target addresses of an indirect branch instruction. In various embodiments, step 610 may include selecting a portion of all target addresses (e.g., selecting three target addresses T1, T2, and T3 from the total set of T1-T5) and determining a respective misprediction rate for each of the selected target addresses. Computer system 100 may then average those rates (e.g., (rate for T1+rate for T2+rate for T3)/3) to determine the average misprediction rate for the set. Accordingly, this average rate may be adjusted by including or removing target addresses from the set.

In step 620, computer system 100 determines whether the average rate is greater than an average threshold M %. Like individual threshold N %, average threshold M % may be selected to maximize instruction throughput. If computer system 100 determines that the average rate (e.g., 20%) is greater than the average threshold M % (e.g., 10%), method 600 proceeds to step 630. Otherwise, method 600 proceeds to step 640.

In step 630, computer system 100 inserts conditional branch instructions for each target address in the set. In various embodiments, computer system 100 may alternatively add additional target addresses to the set and perform steps 610 and 620 again to find the largest possible set that stratifies the criterion before performing step 630. Step 630 may be performed in a similar manner as step 530.

In step 640, computer system 100 does not insert conditional branch instructions for each target address in the set. In various embodiments, computer system 100 may remove target addresses from the set and perform steps 610 and 620 again in order to find a set that has a high enough average.

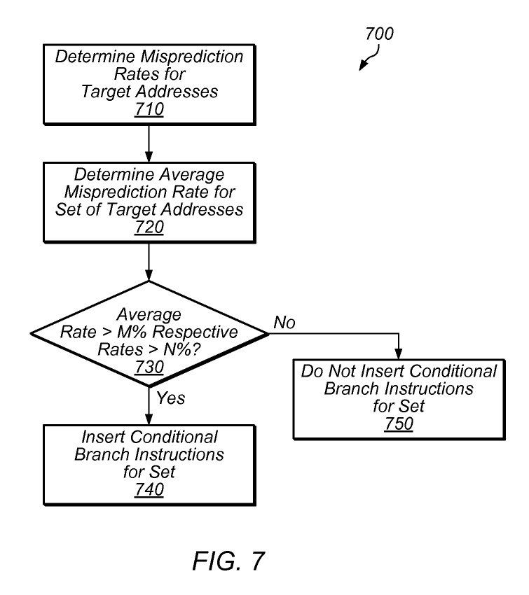

Turning now to FIG. 7, a flow diagram of a method 700 for transforming a sequence of instructions based on an average misprediction rate for a set of target addresses and on their respective misprediction rates is depicted. Method 700 is another embodiment of a method that may be performed by a computer system such as computer system 100 executing module 124. In step 710, computer system 100 determines misprediction rates for target address of an indirect branch instruction (such as described in step 510). In step 720, computer system 100 further determines an average misprediction rate for a set of the target addresses (such as described in step 610). In step 730, computer system 100 determines whether the average rage is greater than the threshold M % and the individual rates are greater than the threshold N %. If the set of target addresses satisfies the criteria, computer system 100 may insert conditional branch instructions for the set in step 740. If the set does not satisfy the criteria, computer system 100 does not insert conditional branch instructions for the set in step 750. In various embodiments, computer system 100 may adjust the set and perform steps 720-730 again before performing steps 740 or 750.

Turning now to FIG. 8, a flow diagram of a method 800 for transforming a sequence of instructions based on a total misprediction rate of an indirect branch instruction is depicted. Method 800 is another embodiment of a method that may be performed by a computer system such as computer system 100 executing module 124. Performance of method 800 may produce similar benefits as other methods described above.

In step 810, computer system 100 determines an initial set of target addresses based on one or more criteria. In various embodiments, step 810 may include performing steps 510 and 520, steps 610 and 620, or steps 710-730 to determine an initial set of target addresses. Thus, the set of target addresses may include those that have an individual rate greater than N %, an average rate greater than M %, and/or a combination thereof.

In step 820, computer system 100 determines a total misprediction rate for the indirect branch instructions. In various embodiments, this total rate may be determined by multiplying each individual rate with that target address's target frequency and summing the results of the multiplications. For example, the total rate for an indirect branch instruction having target addresses T1, T2, and T3 is (misprediction rate of T1* target frequency of T1)+(misprediction rate of T2*target frequency of T2)+(misprediction rate of T3*target frequency of T3).

In step 830, computer system 100 determines whether the total rate is less than a total threshold T %. Like thresholds N % and M %, threshold T % may be selected to maximize instruction throughput. If computer system 100 determines that the total rate is less than the total threshold T %, method 800 proceeds to step 840. Otherwise, method 800 proceeds to step 850.

In step 840, computer system 100 removes one or more target addresses from the set of target addresses determined in step 810. In various embodiments, the number of removed addresses may be a predetermined amount—e.g., remove one target address. In some embodiments, the number of removed addresses may be a function of the difference between the total rate and the threshold T %—e.g., remove more target addresses as the difference increases.

In step 850, computer system 100 inserts conditional branch instructions for the remaining target addresses in the set (such as described in steps 530, 630, or 740).

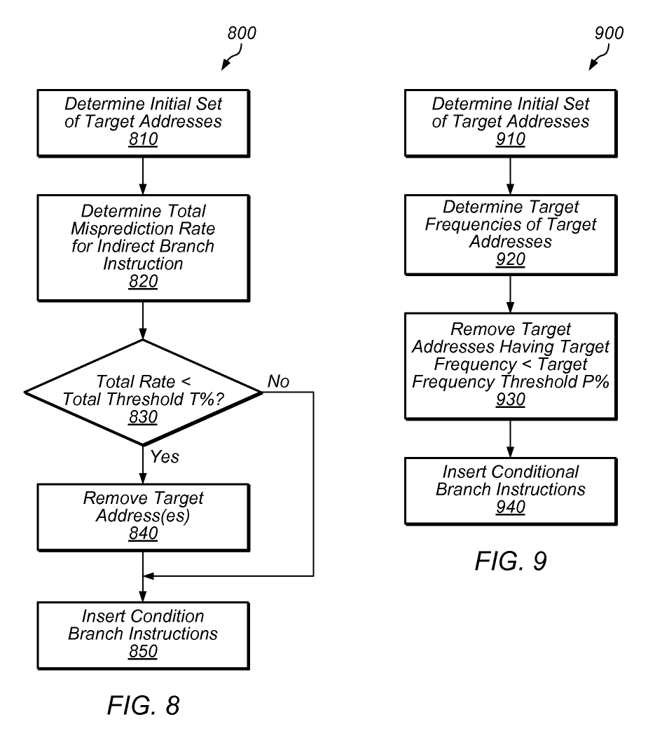

Turning now to FIG. 9, a flow diagram of a method 900 for transforming a sequence of instructions based on a respective target frequency of one or more target addresses is depicted. Method 900 is yet another embodiment of a method that may be performed by a computer system such as computer system 100 executing module 124. In step 910, computer system 100 determines an initial set of target addresses based on one or more criteria (such as in step 810). In step 920, computer system 100 determines a respective target frequency for each of the target addresses in the set. In step 930, computer system 100 removes target addresses from the set that have a respective target frequency less than target frequency threshold P %. In step 940, computer system 100 inserts conditional branch instructions for the remaining target addresses in the set such as described above. In many instances, method 900 may be more efficient than methods 500-800 because conditional branch instructions are not inserted unnecessarily for target addresses that have a low target frequency.

### Exemplary Computer System

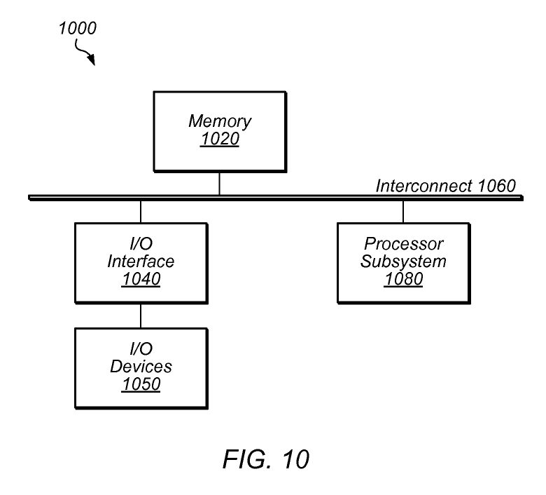

Turning now to FIG. 10, a block diagram of an exemplary computer system 1000 is depicted. Computer system 1000 is one embodiment of a computer system usable to implement computer system 100 described above. As shown, computer system 1000 includes a processor subsystem 1080 that is coupled to a system memory 1020 and I/O interfaces(s) 1040 via an interconnect 1060 (e.g., a system bus). I/O interface(s) 1040 is coupled to one or more I/O devices 1050. Computer system 1000 may be any of various types of devices, including, but not limited to, a server system, personal computer system, desktop computer, laptop or notebook computer, mainframe computer system, handheld computer, workstation, network computer, a consumer device such as a mobile phone, pager, or personal data assistant (PDA). Computer system 1000 may also be any type of networked peripheral device such as storage devices, switches, modems, routers, etc. Although a single computer system 1000 is shown for convenience, system 1000 may also be implemented as two or more computer systems operating together.

Processor subsystem 1080 may include one or more processors or processing units. For example, processor subsystem 1080 may include one or more processing units (each of which may have multiple processing elements or cores) that are coupled to one or more resource control processing elements 1020. In various embodiments of computer system 1000, multiple instances of processor subsystem 1080 may be coupled to interconnect 1060. In various embodiments, processor subsystem 1080 (or each processor unit or processing element within 1080) may contain a cache or other form of on-board memory. In one embodiment, processor subsystem 1080 may include processor 110 described above.

System memory 1020 is usable by processor subsystem 1080. System memory 1020 may be implemented using different physical memory media, such as hard disk storage, floppy disk storage, removable disk storage, flash memory, random access memory (RAM—static RAM (SRAM), extended data out (EDO) RAM, synchronous dynamic RAM (SDRAM), double data rate (DDR) SDRAM, RAMBUS RAM, etc.), read only memory (ROM—programmable ROM (PROM), electrically erasable programmable ROM (EEPROM), etc.), and so on. Memory in computer system 1000 is not limited to primary storage such as memory 1020. Rather, computer system 1000 may also include other forms of storage such as cache memory in processor subsystem 1080 and secondary storage on I/O Devices 1050 (e.g., a hard drive, storage array, etc.). In some embodiments, these other forms of storage may also store program instructions executable by processor subsystem 1080.

I/O interfaces 1040 may be any of various types of interfaces configured to couple to and communicate with other devices, according to various embodiments. In one embodiment, I/O interface 1040 is a bridge chip (e.g., Southbridge) from a front-side to one or more backside buses. I/O interfaces 1040 may be coupled to one or more I/O devices 1050 via one or more corresponding buses or other interfaces. Examples of I/O devices include storage devices (hard drive, optical drive, removable flash drive, storage array, SAN, or their associated controller), network interface devices (e.g., to a local or wide-area network), or other devices (e.g., graphics, user interface devices, etc.). In one embodiment, computer system 1000 is coupled to a network via a network interface device.

Program instructions that are executed by computer systems (e.g., computer system 1000) may be stored on various forms of computer readable storage media. Generally speaking, a computer readable storage medium may include any non-transitory/tangible storage media readable by a computer to provide instructions and/or data to the computer. For example, a computer readable storage medium may include storage media such as magnetic or optical media, e.g., disk (fixed or removable), tape, CD-ROM, or DVD-ROM, CD-R, CD-RW, DVD-R, DVD-RW, or Blu-Ray. Storage media may further include volatile or non-volatile memory media such as RAM (e.g. synchronous dynamic RAM (SDRAM), double data rate (DDR, DDR2, DDR3, etc.) SDRAM, low-power DDR (LPDDR2, etc.) SDRAM, Rambus DRAM (RDRAM), static RAM (SRAM), etc.), ROM, Flash memory, non-volatile memory (e.g. Flash memory) accessible via a peripheral interface such as the Universal Serial Bus (USB) interface, etc. Storage media may include microelectromechanical systems (MEMS), as well as storage media accessible via a communication medium such as a network and/or a wireless link.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. A computer readable medium having program instructions stored thereon, wherein the program instructions are executable by a processor to cause a computer system to perform:
determining misprediction information for an indirect branch instruction included in a sequence of instructions, wherein the misprediction information is indicative of the processor not correctly predicting an actual target address of the indirect branch instruction; and
based on the misprediction information, inserting before the indirect branch instruction a conditional branch instruction that specifies the target address.

2. The computer readable medium of claim 1, wherein the processor is configured to maintain statistical information about the indirect branch instruction, and wherein the program instructions are further executable to read the statistical information from the processor to determine the misprediction information.

3. The computer readable medium of claim 2, wherein the processor includes a plurality of counters, wherein each counter is configured to store a number of mispredictions for a respective target address of the indirect branch instruction.

4. The computer readable medium of claim 1, wherein the program instructions are further executable to perform:
comparing a misprediction rate for the target address with a threshold value; and
inserting the conditional branch instruction in response to the misprediction rate exceeding the threshold value.

5. The computer readable medium of claim of 1, wherein the program instructions are further executable to perform inserting the conditional branch instruction based on the misprediction information and a target frequency of the target address.

6. The computer readable medium of claim of 1, wherein the program instructions are further executable to perform inserting a respective conditional branch instruction for each of a plurality of target addresses of the indirect branch instruction, and wherein the conditional branch instructions are inserted in a particular ordering based on target frequencies of the plurality of target addresses.

7. The computer readable medium of claim 1, wherein the program instructions are further executable to perform:
determining an average misprediction rate for a plurality of target addresses of the indirect branch instruction;
comparing the average misprediction rate with a threshold value; and
inserting a respective conditional branch instruction for each target address based on the comparing.

8. The computer readable medium of claim 1, wherein the program instructions are further executable to perform:
determining a total misprediction rate for all target addresses of the indirect branch instruction; and
inserting the conditional branch instruction based on the misprediction information for the target address and the total misprediction rate.

9. The computer readable medium of claim 1, wherein the program instructions are executable to perform inserting the conditional branch instruction while the processor is executing the sequence of instructions.

10. The computer readable medium of claim 9, wherein the program instructions include instructions of a compiler executable to compile source code to produce the sequence of instructions while the processor is executing a portion of the sequence of instructions.

11. The computer readable medium of claim 9, wherein the program instructions include instructions of a binary translator executable to translate the sequence of instructions while the processor is executing a portion of the sequence of instructions.

12. A method, comprising:
determining a misprediction rate for a target address of an indirect branch instruction; and
based on the misprediction rate, inserting a conditional branch instruction into a sequence of instructions that includes the indirect branch instruction, wherein the conditional branch instruction specifies the target address.

13. The method of claim 12, wherein the inserting is performed while a portion of the sequence of instructions is executing.

14. The method of claim 12, wherein the processor includes a memory used for maintaining the misprediction rate, and wherein the conditional branch instruction is executable to cause the processor to begin fetching instructions at the target address in response to a comparison using the target address.

15. The method of claim 12, further comprising:
determining an average misprediction rate for a plurality of target addresses including the target address, and wherein the inserting is further based on the average misprediction rate.

16. The method of claim 12, further comprising:
determining a target frequency for the target address, and wherein the inserting is further based on the target frequency.

17. The method of claim 12, further comprising:
determining a total misprediction rate for each of target addresses of the indirect branch instruction, and wherein the inserting is further based on the total misprediction rate.

18. A computer readable medium having program instructions stored thereon, wherein the program instructions comprise:
a first conditional branch instruction executable to cause a processor to jump to a first target address based on a comparison of the first target address with an address stored in a register of the processor; and
an indirect branch instruction located after the first conditional branch instruction, wherein the indirect branch instruction is executable to cause a processor to jump to the address stored in the register, wherein the first target address is one of a plurality of target addresses of the indirect branch instruction.

19. The computer readable medium of claim 18, wherein the program instructions further comprise:
a second conditional branch instruction inserted before the first conditional branch instruction and the indirect branch instruction, wherein the second conditional branch instruction is executable to cause the processor to jump to a second target address based on a comparison of the second target address with the address stored in the register;
wherein the second target address is another one of the plurality of target addresses of the indirect branch instruction.

20. The computer readable medium of claim 19, wherein the first target address has a lower target frequency than the second target address.
